(19) United States
(12) Patent Application Publication
(10) Pub. No.: US 2024/0354479 A1
(43) Pub. Date: Oct. 24, 2024

(54) PEFORMANCE ANALYSIS USING ARCHITECTURE MODEL OF PROCESSOR ARCHITECTURE DESIGN

(71) Applicant: Synopsys, Inc., Mountain View, CA (US)

(72) Inventor: Amit Raj Sethi, New Delhi (IN)

(21) Appl. No.: 18/303,800

(22) Filed: Apr. 20, 2023

(51) Int. Cl. G06F 30/3312

(52) U.S. Cl. CPC G06F 30/3312

(57) ABSTRACT

An example is a method. A control flow graph is populated with instances of model objects. Each instance of the instances of the model objects represents a respective stage of a processor architecture design. The instances of the model objects are interconnected in the control flow graph. The interconnected instances of the model objects are an architecture model representing the processor architecture design. The architecture model including the interconnected instances of the model objects is output by one or more processors.

### TECHNICAL FIELD

The present disclosure relates to generating performance information of a processor architecture.

### BACKGROUND

In processor design, determining the performance of a processor architecture may be a step in the design process. A simulation based on a design of the processor may be performed. The results of the simulation may indicate whether the processor design meets various design specifications or whether the processor design should be improved. An iterative process of creating or modifying a processor architecture and simulating the design of the processor may be implemented. Such an approach may enable a satisfactory design of a processor architecture to reach tape out and fabrication, which may be very costly.

### SUMMARY

An example is a method. A control flow graph is populated with instances of model objects. Each instance of the instances of the model objects represents a respective stage of a processor architecture design. The instances of the model objects are interconnected in the control flow graph. The interconnected instances of the model objects are an architecture model representing the processor architecture design. The architecture model including the interconnected instances of the model objects is output by one or more processors.

Another example is a non-transitory computer readable medium. The non-transitory computer readable medium includes stored instructions. The instructions, when executed by a processor, cause the processor to: populate a control flow graph with instances of model objects, interconnect the instances of the model objects in the control flow graph, and output the architecture model including the interconnected instances of the model objects. Each instance of the instances of the model objects represents a respective stage of a processor architecture design. The interconnected instances of the model objects are an architecture model representing the processor architecture design.

A further example is a method. An architecture model representing a processor architecture is generated using one or more processors. The architecture model includes interconnected instances of model objects in a control flow graph. Each instance of the instances represents a respective stage of the processor architecture. A software trace including instructions is received. The instructions are converted to pseudo-instructions that are instruction set architecture (ISA) agnostic. Execution of the pseudo-instructions is simulated using the architecture model. Performance information of the first processor architecture is generated based on the simulation.

### BRIEF DESCRIPTION OF THE DRAWINGS

The disclosure will be understood more fully from the detailed description given below and from the accompanying figures of examples. The figures are used to provide knowledge and understanding of examples and do not limit the scope of the disclosure to these specific examples. Furthermore, the figures are not necessarily drawn to scale.

FIG. 1 is an architecture model of a five stage reduced instruction set computer (RISC) central processing unit (CPU) pipeline according to some examples.

FIG. 2 is an architectural model of a superscalar processor according to some examples.

FIG. 3 is a software trace generated by executing software for a processor according to some examples.

FIG. 4 is pseudo-instructions that are generated from pre-processing the software trace of FIG. 3 according to some examples.

FIGS. 5 and 6 are architecture models, which are modifications of the architecture models of FIGS. 1 and 2, that include model objects mapped to memory drivers according to some examples.

FIG. 7 is a flowchart of a method for analyzing performance of a processor architecture using an architecture model according to some examples.

FIG. 8 is a graphical format of performance information from simulation on the architecture model of FIG. 1 according to some examples.

FIG. 9 is a flowchart of a method of generating an architecture model according to some examples.

FIG. 10 is a flowchart of a method of generating pseudo-instructions from a software trace according to some examples.

FIG. 11 is an architecture model of a simple RISC pipeline implemented in a SystemC environment according to an example.

FIG. 12 is an architecture model of a first superscalar RISC pipeline implemented in a SystemC environment according to an example.

FIG. 13 is an architecture model of a second superscalar RISC pipeline implemented in a SystemC environment according to an example.

FIG. 14 is an example software trace from a cycle accurate processor model according to an example.

FIG. 15 is an example software trace from a loosely timed processor model according to an example.

FIG. 16 illustrates the integration of the architecture model of FIG. 13 with a System-on-Chip (SoC) hardware model according to an example.

FIGS. 17A and 17B are a graphical format of performance information for architecture exploration indicating execution time according to an example.

FIG. 18 is a graphical format of performance information for architecture exploration indicating sequential and parallel execution of instructions according to an example.

FIG. 19 is a representative diagram of a processor architecture.

FIG. 20 is an architecture model of a processor architecture according to an example.

FIGS. 21A, 21B, 21C, and 21D show, in a graphical format, performance information for the processor and SoC performance analysis of a software benchmark trace on the architecture model of a processor architecture according to an example.

FIGS. 22A, 22B, 22C, and 22D show, in a graphical format, performance information for a modified processor and SoC performance analysis of software benchmark trace on the architecture model of the modified processor architecture according to an example.

FIG. 23 is a flowchart of various processes used during the design and manufacture of an integrated circuit in accordance with some examples.

FIG. 24 is a diagram of an example computer system in which various examples may operate.

### DETAILED DESCRIPTION

Aspects of the present disclosure relate to performance analysis using an architecture model of a processor architecture. Performance analysis may include simulating, e.g., on a computer system, execution of a software program or application on a model of a processor, from which performance information is obtained. Performance metrics, such as cycles-per-instruction (CPI) or instructions-per-cycle (IPC), of a processor architecture may be important for determining whether the processor architecture meets design specifications and/or for architecture exploration of different architectures. Various approaches have been implemented for such performance analysis; however, such approaches have technical limitations and problems.

One approach is based on untimed or loosely timed models. Untimed or loosely timed models may not have accurate timing in the simulation, and hence, may not be useful for performance analysis. Another approach uses statistical models, which are theoretical models. Statistical models may be used for high level architectural analysis but may not be useful for performance analysis of a processor architecture since the models cannot execute an actual software program or application. Another approach implements trace driven models that run execution instruction traces of actual software on a model. For some software applications, the traces may be large, which may result in a long simulation time and may slow simulation speed. Further, the traces may carry a timing fingerprint specific to the processor model from which the trace was collected, and hence, the traces may not adapt correctly for a new processor architecture that is being analyzed. Another approach uses task based models that represent processing time and memory traffic without implementing architecture details of the processor. Task based models generally cannot be easily modified to represent a different architecture. Also, task based models may not scale easily for large traces. Another approach is based on cycle accurate or approximate models. These models require detailed and complex modeling, and are therefore difficult and time consuming to implement. Cycle accurate or approximate models typically require software stacks including bootcode and interrupt service routines and typically require compilers and toolchains. Moreover, cycle accurate or approximate models are available after the register transfer level (RTL) description of the processor has been implemented, which may defeat a purpose of architecture exploration.

The present disclosure describes simulating execution of pseudo-instructions using an architectural model of a processor architecture to determine performance of the processor architecture, where the pseudo-instructions are generated from a software trace and may be agnostic with respect to the instruction set architecture (ISA) of the processor architecture being modeled. An architecture model may include any number of model objects. A model object includes a representation of a stage of a processor architecture. Examples of stages include a fetch stage, a decode stage, a dispatch stage, an execute stage, a writeback stage, and a completion stage. Examples of an execute stage includes a compute stage and a load-store stage. A model object, depending on the type of stage being represented, may represent control logic, timing, and/or memory access behavior of the stage. In some examples, the model object does not implement the non-memory access functional behavior of the stage, such as the computation of a compute stage. Model objects are connected in a control flow graph, as the architecture model, to represent the processor architecture. The processor architecture may include one or multiple pipelines, with each pipeline including various model objects. A trace, which may be obtained from another source, including the executed instructions is converted into pseudo-instructions, which may be architecturally agnostic. Execution of the pseudo-instructions is then simulated in the architecture model (e.g., instructions and/or pseudo-instructions flowing in the control graph) to determine performance information (e.g., CPI, IPC, number of parallel instructions executed, etc.) for performance analysis. In some examples, the architectural model is extended to a system-on-chip (SoC).

Technical advantages of the present disclosure include, but are not limited to, determining accurate performance information, including control logic, timing, and memory access behavior, of a processor architecture based on a software trace that may originate from a different processor architecture. Using a software trace from a different processor architecture may obviate a need for a compiler and/or bootcode for the processor architecture being modeled. Further, implementing the architecture model and pseudo-instructions may permit a lightweight simulation that is fast and easily scalable for large workloads. An architecture model may be easily reconfigurable to create architecture variants for architecture exploration. Additionally, an architecture model may be mapped into a hardware model of a SoC to determine workloads for full system performance of the SoC. Other benefits and advantages may be achieved in various examples.

An architecture model of a processor is an execution model, which may be created in any high-level hardware modeling environment or programming language, such as SystemC. Model objects within the architecture model represent various pipeline stages of the processor architecture, such as fetch, decode, dispatch, compute, load-store, writeback, and completion. The model objects represent the control logic, timing, and memory access behavior of the respective pipeline stages and need not implement the non-memory access functional behavior of the respective pipeline stages. For example, a compute model object, in some examples, does not implement in simulation the actual computation of the respective stage. The absence of non-memory access functional behavior implementation may mean that the model objects cannot perform actual processing or operations of the processor. However, the model objects may have accurate control logic, timing, and memory access information. Hence, the model objects may be used for performance analysis of the processor.

For clarity, reference to a model object herein, without a qualifier referencing a class or in the absence of other context, refers to an instance of a model object that may populate an architecture model. A class of a model object may broadly refer to a common definition of a type of model object. An instance of a model object may include, for example, a task in a task-based programming environment.

An architecture model may be agnostic with respect to any particular instruction set architecture (ISA) implemented by the processor modeled by the architecture model. Hence, an architecture model of a given processor can receive a software trace generated by execution of software or processor instructions on another processor and can perform an execution based on that software trace. This may allow a software trace obtained from one processor to be used as workload for performance comparison of a different processor architecture, which may be existing or may be newly designed. Further, an architecture model may be easier to implement and modify as per new architecture designs and may have much faster simulation speed than a full functional, cycle-accurate model, which may allow faster turn-around time for performance studies.

Control logic, timing, and memory access behavior of a pipeline of a processor may be modeled by one or more model objects in an architecture model. The control logic behavior of a pipeline may include instruction order, instruction dependency, instruction parallelism, and stalls. Instruction ordering refers to the order in which instructions are fetched, decoded, executed, and/or completed. Instruction ordering may be in-order or out-of-order with respect to the input program (e.g., trace) order, as defined by the processor architecture. Instruction dependency refers to rules or conditions that govern when an instruction may be executed based on a preceding one or more instruction(s). Instruction parallelism refers to a number of simultaneous instructions fetched, decoded, and/or executed. Stalls may occur due to dependencies between instructions enforced by the ISA or availability of hardware resources (e.g., buffers, execute units, etc.). The timing behavior of a pipeline may include, but is not limited to, latency of each of the pipeline stages within the pipeline, delays caused due to stalls, and delays caused due to memory accesses. The memory access behavior of a pipeline may include, but is not limited to, (i) address, type (e.g., read or write), and size of memory access from a particular pipeline stage (e.g., fetch and/or load-store) and (ii) a number of parallel memory access requests.

Example stages of a processor pipeline include a fetch stage, a decode/dispatch stage, an execute stage, and a completion stage. Each stage may be modeled by a model object. The corresponding model object may represent control logic, timing, and/or memory access behavior and does not implement the non-memory access functionality of the respective stage.

In a processor architecture, a fetch stage may read instructions from instruction memory and maintain a program counter that points to the address of the memory from which the next instruction is to be read.

A fetch model object reads an instruction from an identified trace file (e.g., instead of reading from memory). Since the trace file provides a record of an already executed program, the fetch model object is not required to maintain a program counter. The fetch model object may read memory using a program counter given in the trace file if, for example, modeling the fetch stage's memory traffic and latency is desired. However, in various examples, data read from memory may not be used. The fetch model object reads the instructions from the trace file and sends the read instructions to a decode and dispatch model object. The number of instructions sent per cycle may be defined by the processor architecture being modeled. Any delay between sending successive instructions may vary upon the read latency from the memory, if implemented.

In a processor architecture, a decode and dispatch stage may generally decode the instruction that was fetched and sent from the fetch stage to determine the instruction type. The decode and dispatch stage may read the value of any operands, if applicable. The decode and dispatch stage may check the dependencies of the instruction and send the instruction to an execute unit for execution, if any dependencies have been met. If dependencies have not been met, the decode and dispatch stage may hold the instruction in a dispatch buffer and decode the next instruction, or may stall further decoding.

A decode model object assigns a unique identifier (ID) to each instruction. The decode model object also identifies the mnemonic in the received instruction as per the instruction set architecture (ISA) of the processor from which the trace was obtained. The decode model converts the mnemonic into a pseudo mnemonic, and the decode model attaches the pseudo mnemonic to the instruction. The pseudo mnemonic may be assigned according to the execute model object on which the instruction is to be executed. This helps the dispatch model object to determine to which execute model object the instruction needs to be sent. Since model objects do not implement the non-memory access functionality of the corresponding stage, stages that have the same control logic, timing, and memory access behavior may be represented by a same instance of a model object, even when the functionality implemented by the stages differ. Hence, in some examples, instructions of the trace file that have different mnemonics (and that would be dispatched to different stages in actual execution) may be assigned a same pseudo mnemonic and dispatched to a same instance of an execute model object.

Based on the incoming instruction, the decode model object also determines the types of dependencies for the instruction and identifies any other instruction(s) on which that instruction depends. The decode model object attaches to the instruction the ID(s) of the instruction(s) upon which the instruction depends. The ID of a dependency is used by the dispatch model object to determine when the instruction is ready to be dispatched for execution. For load/store type instructions, the memory address(es) and access size(s) are also determined by the decode model object from the instruction and are attached to the instruction. The memory address(es) and access size(s) are used by the load/store unit to perform the memory operation.

The dispatch model object puts the incoming instruction into an in-flight queue. The dispatch model object then checks the pseudo mnemonic and the dependencies of the instructions in this queue and attempts to send the instructions to the designated execute model object if the dependencies have been met (e.g., all the other instructions upon which a given instruction depends have already been completed). If the dependencies are not met, then the instruction waits in the in-flight queue until the instruction can be sent. Based on the processor architecture being modeled, the instruction may be sent out-of-order from the in-flight queue if the dependencies of the latter instructions are met before the dependencies of an instruction prior to the latter instruction. Also, based on the processor architecture being modeled, more than one instruction may be sent per cycle to one or more execute units. After an instruction has been sent, it is marked as “SENT” but the instruction is not removed from the in-flight queue until execution of that instruction completion is flagged by a completion model object.

In a processor architecture, an execute stage performs functional operation as per the instruction type and its parameters. A processor may include one or more execute units, which may be connected either sequentially or in parallel.

An execute model object may be or include various execute units based on the processor architecture. For a simple processor like a reduced instruction set computer (RISC) central processing unit (CPU), an execute unit may be an arithmetic logic unit (ALU), a multiply unit (MUL), a load and store unit (LOAD/STORE), a branch unit (BRANCH), a floating point unit (FPU), etc. In an architecture model, the control logic and timing behavior of each unit is modeled. The non-memory access functional behavior of the units may not be modeled. For example, for an ALU or MUL, the actual computation of operands and calculation of a result is not modeled. Rather, the latency of the ALU or MUL is modeled. The latency for any unit may be fixed or variable. For example, for a LOAD/STORE, latency of the load/store operation depends on the time taken to read/write the data from/to cache or memory, which can vary depending upon the architecture or load in the system. In such a case, the actual load/store operation may be performed by the LOAD/STORE, and the latency encountered is taken into account. For complex processors, like a graphics processing unit (GPU) or artificial intelligence (AI) engine, an execute unit may be a composite that includes various micro or macro operations such as load, compute, and store, or may even include a mini-pipeline internal to the execute unit. Such execute units may also be modeled as control and timing units.

In a processor architecture, a completion stage may store the result of the execution of an instruction and retire the instruction. A completion model object receives the instruction from the execute model object and sends to the dispatch model object the instruction with a completion marking. The instruction may be explicitly marked as “DONE” or similar marking before sending. The completed instructions are then retired (e.g., removed) from the in-flight queue in the dispatch model object. The retiring of instructions is typically performed in the order in which the instructions were received from the Fetch model object to maintain the correct program order.

Various model objects are connected as a control flow graph (e.g., a task graph) to represent a pipeline structure and topology of a given processor. Different kinds of topologies, varying from simple scalar pipelines, like RISC CPUs to complex superscalar pipelines like AI engines and GPUs, can be implemented using this technique.

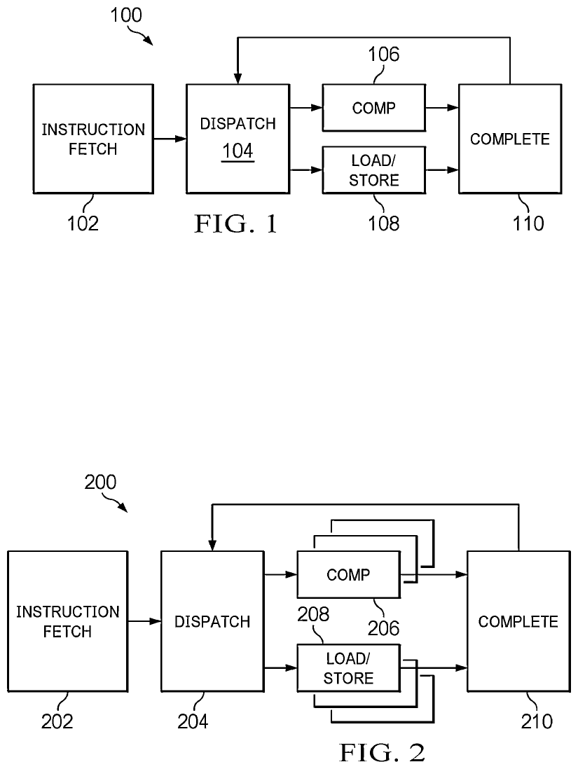

Depending on the processor type and/or architecture being modeled, the number and kind of pipeline stages may vary. As an example, FIG. 1 is an architecture model 100 of a five stage RISC CPU pipeline. The architecture model 100 includes a fetch model object 102, a dispatch model object 104, a compute model object 106, a load/store model object 108, and a completion model object 110. In the architecture model 100, the execute unit is split into two parallel model objects—the compute model object 106 (e.g., an ALU model object) and the load/store model object 108. As another example, FIG. 2 is an architectural model 200 of a superscalar processor. The architecture model 200 includes a fetch model object 202, a dispatch model object 204, multiple parallel compute model objects 206, multiple parallel load/store model objects 208, and a completion model object 210. As illustrated by the architecture model 200, a superscalar processor may have multiple parallel execute model objects (e.g., the compute model objects 206 and load/store model objects 208) of the same kind. A superscalar processor, and hence, a corresponding architecture model, may also have a branch prediction or prefetch stage, and corresponding model object, to improve overall pipeline efficiency. An AI processor may have each execute stage as a macro unit that includes multiple sub-units that perform the basic load, compute, and store operations.

The architecture model executes a software trace as pseudo-instructions. The software trace may be obtained from executing an actual software binary on (i) any simulation model or development board having a desired processor, (ii) a variant of the processor with a similar or previous generation architecture, or (iii) a processor of dissimilar architecture. The simulation model may or may not have the actual or any instruction or pipeline timings of the particular architecture. The trace of the software may include relevant instruction execution without timing information.

A software trace can be pre-processed, and in the pre-processing, the instructions of the software trace can be converted into pseudo-instructions based on the type of execute stage in which the respective instruction would execute. Different types of instructions may be converted into a same type of pseudo-instruction, if, for example, the same control logic, timing, and/or memory access applies to the different types of instructions, even regardless of underlying operation and/or operands of those instructions. Whether various types of instructions may be converted to a same type of pseudo-instruction may depend on the processor architecture being modeled. Two different types of instructions in one processor architecture being modeled may have the same control logic, timing, and memory access, but those same two different types of instructions in another processor architecture being modeled may have different control logic, timing, and/or memory access.

As an example, for a RISC CPU, ALU and move instructions may be replaced by a single type pseudo-instruction “ALU”. Similarly, branch and jump instructions may be replaced by a single type pseudo-instruction “BRANCH”; multiply instructions may be replaced by a pseudo-instruction “MUL”; load instructions may be replaced by a pseudo-instruction “LOAD”; store instructions may be replaced by a pseudo-instruction “STORE”; and so on. A similar conversion can be performed for various processor architectures, including AI and GPU processors, where each instruction can represent one or more composite operation(s), like convolution, matrix multiply, load (e.g., data from double data rate (DDR) memory to static random access memory (SRAM)), store (e.g., data from SRAM to DDR), etc.

Also, during pre-processing, instruction dependencies are determined. A dependency may be appended to a respective pseudo-instruction. The pre-processing of a software trace may be performed by a decode model object, as indicated previously.

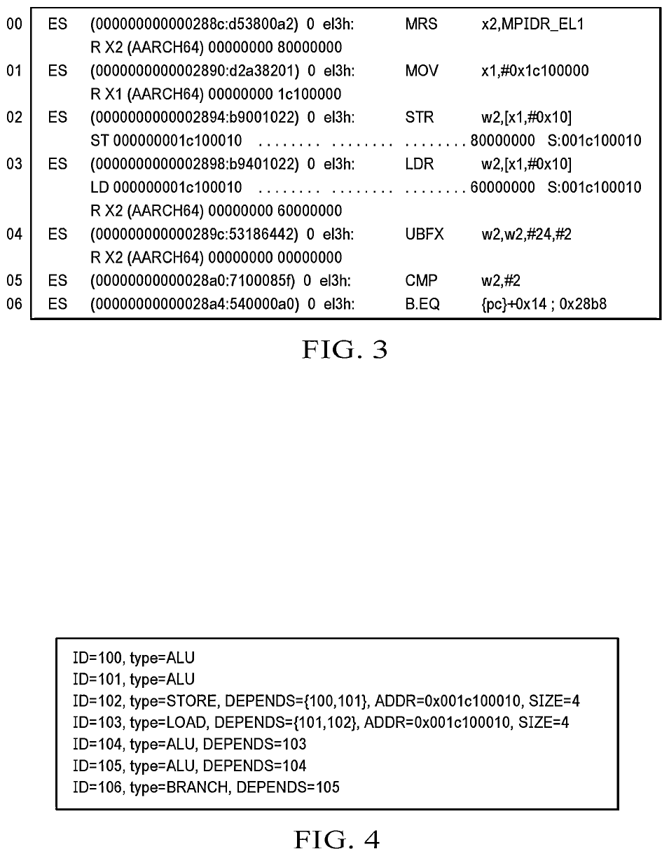

FIG. 3 is a software trace generated by executing software for a processor, and FIG. 4 shows corresponding pseudo-instructions that are generated from pre-processing the software trace of FIG. 3 according to some examples. The software trace of FIG. 3 includes seven instructions. Line 00 is a move from special register to general register instruction with the mnemonic MRS. Line 01 is a move instruction with the mnemonic MOV. Line 02 is a load register instruction with the mnemonic LDR. Line 03 is an unsigned bit field extract instruction with the mnemonic UBFX. Line 05 is a compare instruction with the mnemonic CMP. Line 06 is a branch if equal instruction with the mnemonic B.EQ.

Referring to FIG. 4, the pre-processing assigns the instruction at line 00 in FIG. 3 the unique ID=100 and converts the instruction to an ALU pseudo-instruction. The instruction at line 01 is assigned the unique ID=101 and is converted to an ALU pseudo-instruction. The instruction at line 02 is assigned the unique ID=102 and is converted to a STORE pseudo-instruction with dependencies from the ID=100, 101 pseudo-instructions. The instruction at line 03 is assigned the unique ID=103 and is converted to a LOAD pseudo-instruction with dependencies from the ID=101, 102 pseudo-instructions. The instruction at line 04 is assigned the unique ID=104 and is converted to an ALU pseudo-instruction with a dependency from the ID=103 pseudo-instruction. The instruction at line 05 is assigned the unique ID=105 and is converted to an ALU pseudo-instruction with a dependency from the ID=104 pseudo-instruction. The instruction at line 06 is assigned the unique ID=106 and is converted to a BRANCH pseudo-instruction with a dependency from the ID=105 pseudo-instruction. Further, the pseudo-instructions ID=102, 103 include the respective address and size of the respective memory access of that pseudo-instruction.

As illustrated by the pre-processing indicated by FIGS. 3 and 4, the model object (e.g., the decode model object) that performs the pre-processing receives or determines the ISA of the software trace that the model object receives and translates instructions in that ISA to the pseudo-instructions. In the illustrated example, the MRS, MOV, UBFX, and CMP instruction types in FIG. 3 were converted to ALU pseudo-instructions in FIG. 4 based on the control logic, timing, and memory access of the respective execute stages of the processor architecture being modeled.

Further, any non-memory access operation of the instructions of the software trace of FIG. 3, including any operands, is stripped in the conversion to the pseudo-instructions of FIG. 4. For example, the operands of the MRS, MOV, UBFX, and CMP instructions in FIG. 3 are removed in the pseudo-instructions of FIG. 4, and the indicated operations of the mnemonics of the MRS, MOV, UBFX, and CMP instructions are removed by the translation to a generic ALU pseudo-instruction.

The operands of instructions in the software trace may be used in determining dependencies. For example, referring to FIG. 3, the UBFX instruction at line 04 extracts data from the data stored in register w2, which is previously loaded by the LDR instruction at line 03. Hence, in this example, the data that is to be extracted by the instruction at line 04 depends on the data that is loaded by the instruction at line 03. In the pre-processing, the model object determines this dependency such that the pseudo-instruction ID=104 (that corresponds to the instruction at line 04) includes a dependency from the pseudo-instruction ID=103 (that corresponds to the instruction at line 03).

By stripping non-memory access operation and functionality from the instructions when translating to pseudo-instructions, the pseudo-instructions may be lightweight instructions where simulation of execution of the pseudo-instructions may be faster. Simulation of execution of the non-memory access function may be avoided, while maintaining proper control logic, timing, and memory access for performance analysis.

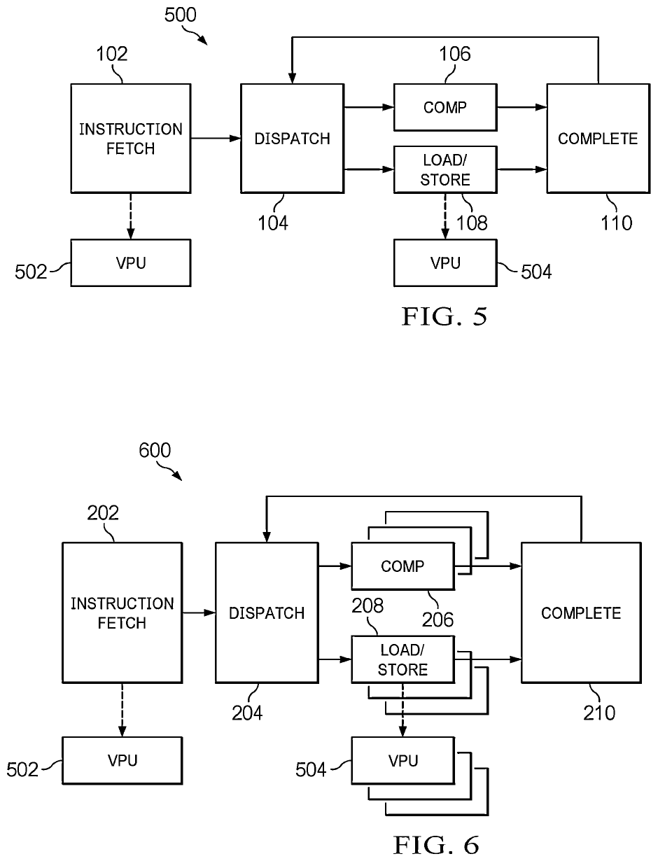

In some examples, memory read operations from a fetch model object and from a load model object, and memory write operations from a store model object, are fed to a bus driver, which can be used as application workload (e.g., traffic) for system level performance analysis of a system interconnect, caches, and memories. Since the memory read and write operations use the address and data size information from corresponding instructions and are issued in the order and timing governed by the software trace and the hardware architecture, the memory read and write operations may represent the software workload quite accurately. FIGS. 5 and 6 illustrate architecture models 500, 600, which are modifications of the architecture models 100, 200 of FIGS. 1 and 2, respectively, by virtual processing units (VPUs) 502, 504 communicatively coupling to the fetch model object 102, 202 and the load/store model object 108, 208 as respective memory drivers. The VPUs 502, 504 are mapped to memory drivers, which are connected to interconnect and memory models to form a SoC system.

Additionally, for a SoC system, an architecture model may be connected to traffic drivers to be simulated as a SoC platform. A traffic driver can be a model which can generate transactions which can be sent for accessing the memory. The memory accesses from the pipeline stages, such as fetch and load/store, may be converted to bus protocol transactions, such as advanced extensible interface (AXI) transactions. This transaction information is then sent to the traffic driver which generates transaction-level modeling (TLM) transactions as per the given protocol (e.g., AXI). The traffic driver is connected to the SoC interconnect or bus, through which the TLM transactions are sent to caches or memories. Delays and instruction stalls due to fetch, load, and store may be reflected accurately in the simulation based on the latencies encountered in accessing the caches or the memories. Memory traffic from the architecture model may be used as a workload for the SoC level performance analysis and re-design of hardware, such as cache sizes, interconnect topologies and memory configurations.

Implementing an architecture model as described above may permit more efficient architecture exploration of a processor architecture. A goal of architecture exploration may include determining how fast a given processor architecture can execute a given software program. This speed may be measured as instructions per cycle (IPC) or cycles per instruction (CPI). In architecture exploration and in comparing two or more processor architectures, an actual or a representative software application (e.g., a benchmark) may be run on each of the processors and their IPC and/or CPI values may be compared. The processor having the highest IPC or the lowest CPI would be the fastest. The processors to be compared may belong to the same or alike families of architectures, or may be of very different architecture types.

When creating a new processor design, different hardware options, like pipeline structure, number and/or type of execute units, dispatch/retire policies, memory/interconnect designs, etc. may be explored. In such cases, the benchmark software needs to be executed or simulated on each of the processors. When an architecture is new and no compiler or boot program is as yet available for the architecture or when the processor architectures are very different in which case different compilers and boot programs may be required for each processor, executing the benchmark software on each of the processors may be difficult, or even impossible.

With architecture models as described herein, a performance analysis may be obtained without a compiler and without a boot program for the different processor architectures or each variant of the processor architecture. Different pipeline architectures may be created by using the same models of the pipeline stages into different topologies and by varying the execute model objects by adding more instances or changing runtime parameters of model objects. Since these models use pseudo-instructions instead of the actual instructions as per the processor ISA, the same pseudo-instruction may be run as-is on the architecture model of different architectures having a different pipeline structures, different numbers of execute model objects, and/or different policies for dispatch/retire, etc.

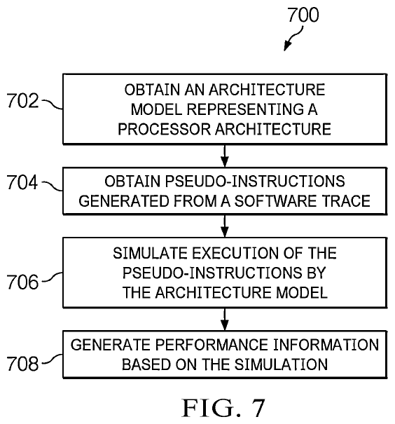

FIG. 7 is a flowchart of a method 700 for analyzing performance of a processor architecture using an architecture model according to some examples. At 702, an architecture model representing a processor architecture is obtained. The architecture model may be a control flow graph including interconnected instances of model objects that represent the processor architecture. The architecture model may represent control logic, timing, and memory access behavior of the processor architecture without implementing non-memory access functional behavior of the processor architecture.

At 704, pseudo-instructions generated from a software trace are obtained. The software trace may be generated from execution or simulation of execution of a software program on a processor having a different architecture from the processor architecture being modeled by the architecture model. The software trace may be according to an ISA of the processor on which the execution or simulation of execution was performed. The pseudo-instructions may be ISA agnostic. Each pseudo-instruction may include: (i) a mnemonic indicating which type of a model object executes the corresponding instruction of the software trace, (ii) a unique ID, (iii) any dependency (ies) of other pseudo-instructions, and (iv) for any memory access pseudo-instruction, the memory address and access size of the memory access. The pseudo-instruction may, in some examples, not include operands for non-memory access functional behavior of the corresponding instruction of the software trace.

At 706, execution of the pseudo-instructions by the architecture model is simulated. In some examples, obtaining the pseudo-instructions may be included in the simulation. In some examples, a fetch model object of the architecture model obtains instructions from the software trace. The fetch model object communicates the instructions to a decode and dispatch model object. The decode and dispatch model generates the pseudo-instructions from the instructions of the software trace. The decode and dispatch model then routes each pseudo-instruction to an appropriate instance of an execution model object based on the mnemonic of the respective pseudo-instruction and in an order according to the applicable control (e.g., any dependency) and resource (e.g., execution model object) availability. At the instances of execution model objects, the latency of the execution is determined, including any latency for memory access. Once the latency of the execution is determined, the instances of execution models communicate the respective pseudo-instructions to a completion model object, which communicates completion of the pseudo-instructions to the decode and dispatch model object. The decode and dispatch model object retires completed pseudo-instructions.

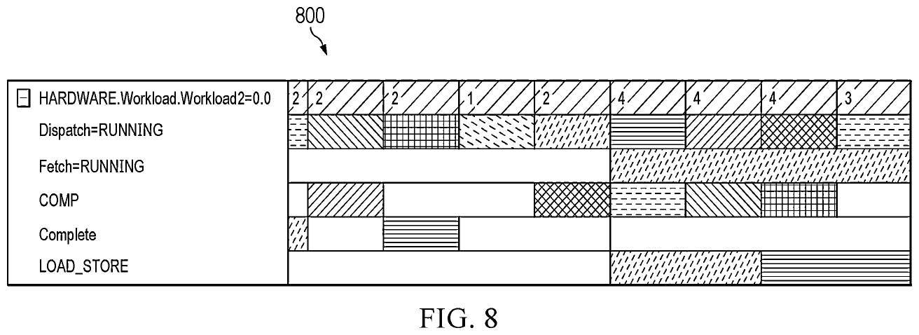

At 708, performance information is generated based on the simulation at 706. The performance information may be displayed in a graphical format (e.g., on a video display unit of a computer system). For example, the graphical format may include an axis that lists the instances of the model objects and another, perpendicular axis that corresponds to execution time. The time and duration that each pseudo-instruction is at a given instance of a model object may be indicated graphically in the graphical format. FIG. 8 is an example graphical format 800 of performance information from simulation on the architecture model 100 of FIG. 1. The vertical axis indicates instances of model objects such as fetch, dispatch, compute (COMP), load/store (LOAD_STORE), and completion (complete), and the horizontal axis indicates time. The boxes within the graph indicate the time at which the corresponding model object executed a respective pseudo-instruction and the duration of that execution.

In some examples, based on the performance information obtained at 708, the processor architecture, and hence, the architecture model, may be re-designed or re-worked. The method 700 may be implemented again on the re-designed architecture. Hence, the method 700 may be an iterative process whereby an architecture model is re-designed or re-worked until the architecture model produces satisfactory performance information.

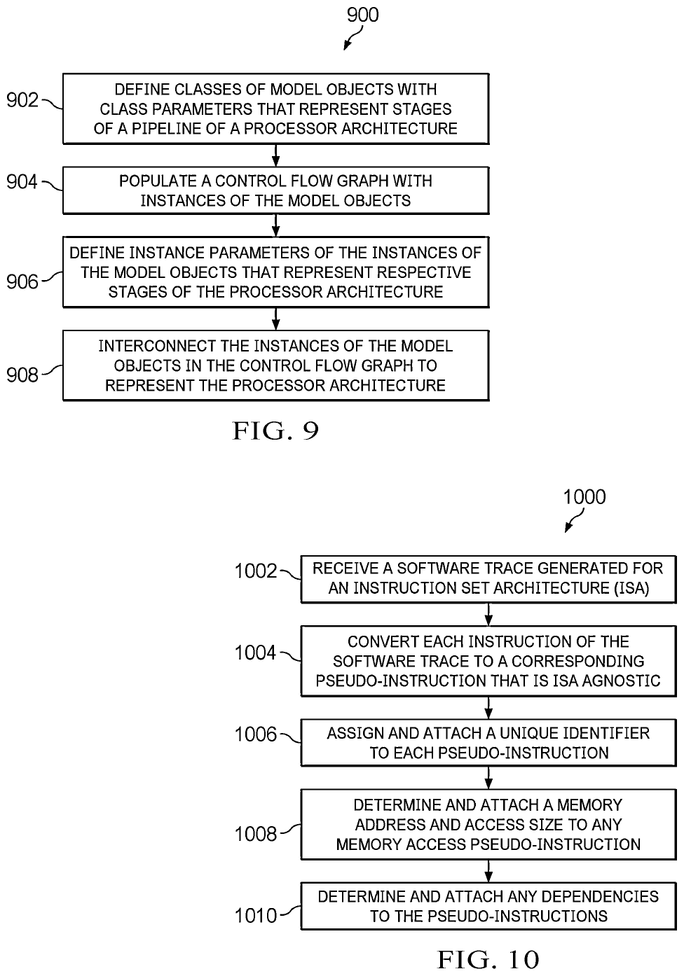

FIG. 9 is a flowchart of a method 900 of generating an architecture model according to some examples. The method 900 may be implemented to obtain the architecture model at 702 of FIG. 7. At 902, classes of model objects are defined with class parameters. The classes of model objects, with the class parameters, represent respective stages of a pipeline of a processor architecture to be modeled. A class parameter of a given class of model object may apply to each instance of that class of model object. For example, all instances of the compute model object 206 in the architecture model 200 of FIG. 2 may have a same or different latency, and hence, the latency may be a class parameter for the class of compute model object. The classes may be defined according to respective functionality of the class (e.g., including function calls to provide such functionality) implemented by the architecture model, such as described above. Definitions of classes of model objects may vary and may or may not include class parameters.

At 904, a control flow graph is populated with instances of the model objects. Each stage of the processor architecture corresponds to an instance of a model object in the control flow graph. At 906, instance parameters of the instances of the model objects are defined. The instances of model objects, with the instance parameters, represent the stages of the processor architecture being modeled. The instance parameters may permit different instances of a model object to have different characteristics. For example, if instances of the compute model object 206 in the architecture model 200 of FIG. 2 have different latencies, and the latency of each instance of the compute model object 206 may be an instance parameter that may be separately defined for each instance of the compute model object 206. At 908, the instances of the model objects are interconnected in the control flow graph to represent the processor architecture.

FIG. 10 is a flowchart of a method 1000 of generating pseudo-instructions from a software trace according to some examples. The method 1000 may be implemented to obtain the pseudo-instructions at 704 of FIG. 7. The method 1000 of FIG. 10 may be implemented by definition of a class of decode model object and/or an instance of a decode model object in an architecture model.

At 1002, a software trace generated for an ISA is received. The software trace includes instructions that are each formatted according to the ISA. At 1004, each instruction of the software trace is converted to a corresponding pseudo-instruction that is ISA agnostic. For example, the mnemonic of the instruction can be used to identify a corresponding mnemonic of a pseudo-instruction. A look-up table or other functionality may be used to convert the instructions to pseudo-instructions. At 1006, a unique ID is assigned and attached to each pseudo-instruction. At 1008, a respective memory address and access size are determined and attached to any memory access pseudo-instruction. At 1010, any dependencies indicated in the software trace are determined and attached to the corresponding pseudo-instructions.

According to one embodiment, model objects are created in a SystemC environment, and multiple architecture models were created in the SystemC environment using the model objects. The architecture models modeled multiple RISC CPU architectures with different pipeline topologies and configurations. Each RISC CPU architecture included: a fetch model object (Fetch), a dispatch/decode model object (Dispatch), a compute model object (COMP), a load/store model object (LOAD_STORE), and a completion model object (Complete). The Fetch reads a sequence of commands (e.g., instructions) from a JSON file which are derived from a software execution trace. The commands contain information on fetch, execute type, and command dependency. The Fetch does memory access for the instruction fetch type commands using a given program counter as the address and sends the data access type commands to the Dispatch. The Dispatch converts the commands to pseudo-instructions and issues pseudo-instructions to COMP or LOAD_STORE depending on the type of pseudo-instructions. The Dispatch stalls the issuance of a pseudo-instruction if the sequence on which the pseudo-instruction depends has not completed. The Dispatch can issue pseudo-instructions out-of-order if the pseudo-instructions have no dependency or the pseudo-instructions on which they depend have completed. The Dispatch maintains a list of pseudo-instructions which are issued and not completed (in-flight), and upon receiving a notification from the Complete, removes them in-order. COMP represents a computation unit and consumes a fixed delay. LOAD_STORE performs memory access for the LOAD_STORE type pseudo-instructions using memory address and access size information in the respective pseudo-instruction. LOAD_STORE can issue multiple outstanding read/write pseudo-instructions. Complete gathers the pseudo-instructions as the pseudo-instructions become completed from the COMP or LOAD_STORE, and sends notification to the Dispatch.

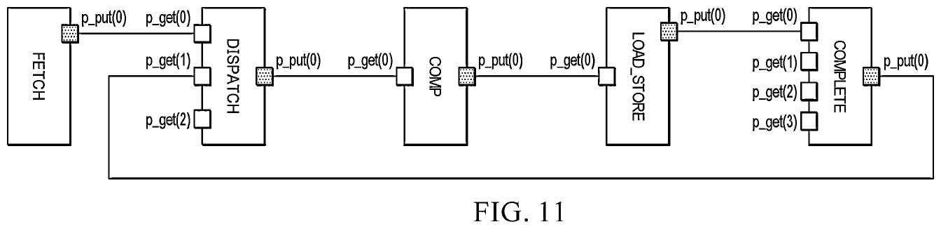

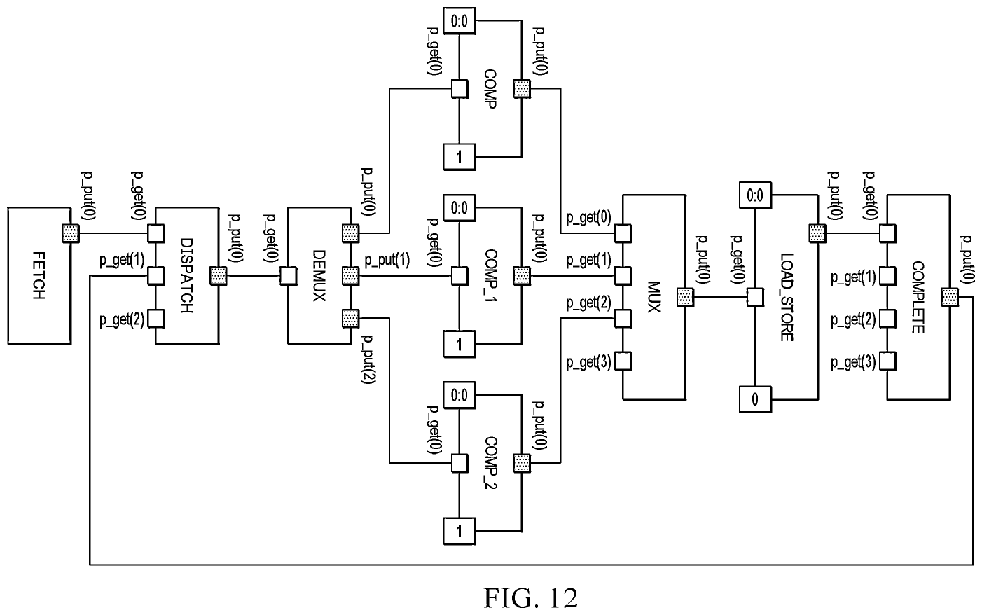

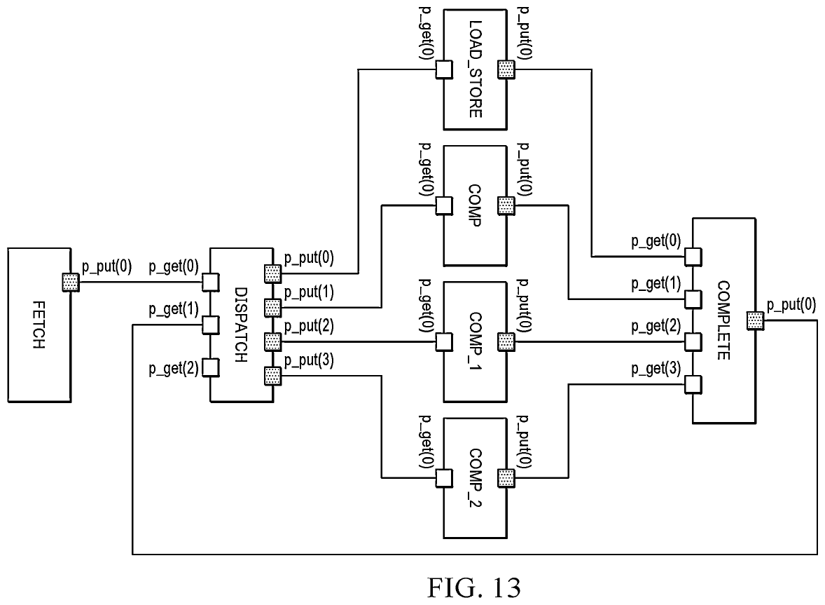

FIG. 11 is an architecture model of a simple RISC pipeline implemented in the SystemC environment. The architecture model includes a Fetch, a Dispatch, one COMP, one LOAD_STORE, and a Complete interconnected in a control flow graph. FIG. 12 is an architecture model of a first superscalar RISC pipeline implemented in the SystemC environment. The architecture model includes a Fetch, a Dispatch, three parallel COMP, one LOAD_STORE, and a Complete interconnected in a control flow graph. The three COMP may execute up to three COMP type commands in parallel. FIG. 13 is an architecture model of a second superscalar RISC pipeline implemented in the SystemC environment. The architecture model includes a Fetch, a Dispatch, three COMP, one LOAD_STORE, and a Complete interconnected in a control flow graph. The three COMP and one LOAD_STORE may execute up to three COMP type commands and one LOAD_STORE type command in parallel.

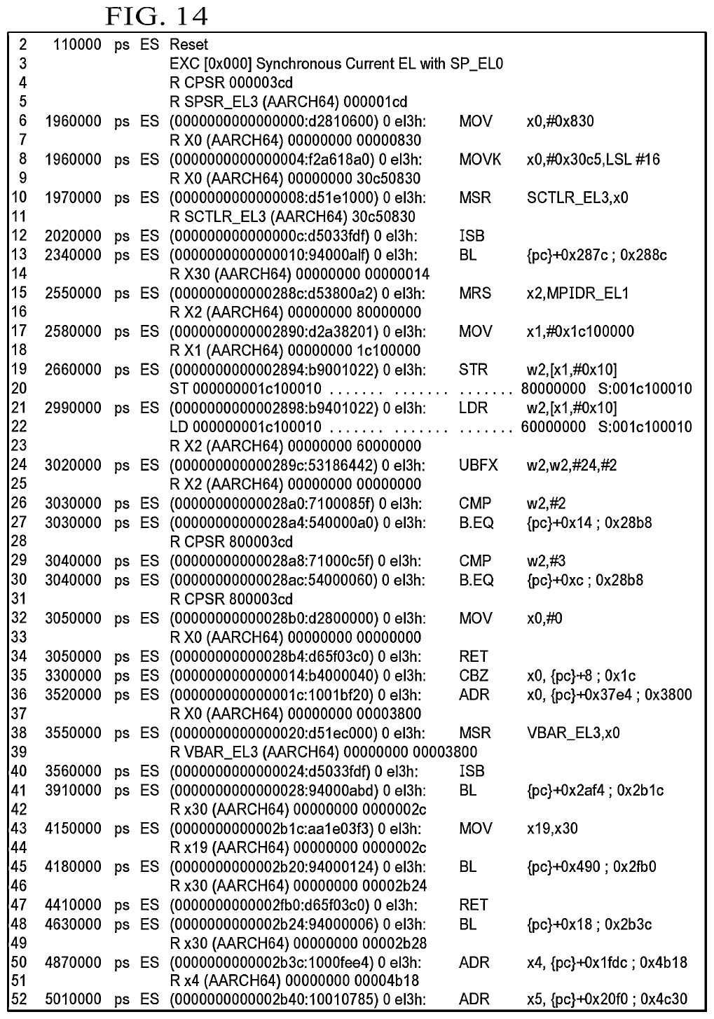

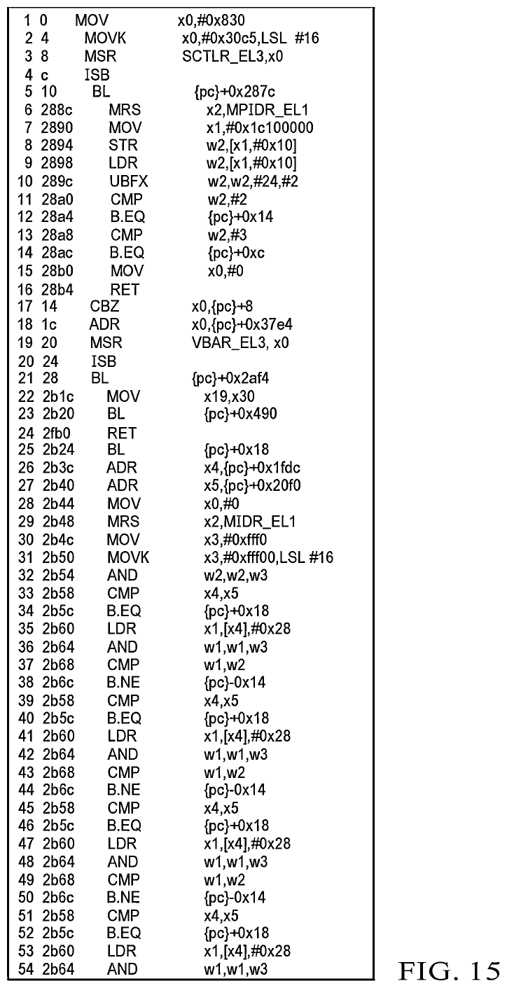

A parsing and adaptation utility was created to read software instruction traces. Further, the parsing and adaptation utility was created to read software instruction traces from different types of simulators, such as a loosely timed simulator and a cycle accurate simulator. FIG. 14 is an example software trace from a cycle accurate model. FIG. 15 is an example software trace from a loosely timed model.

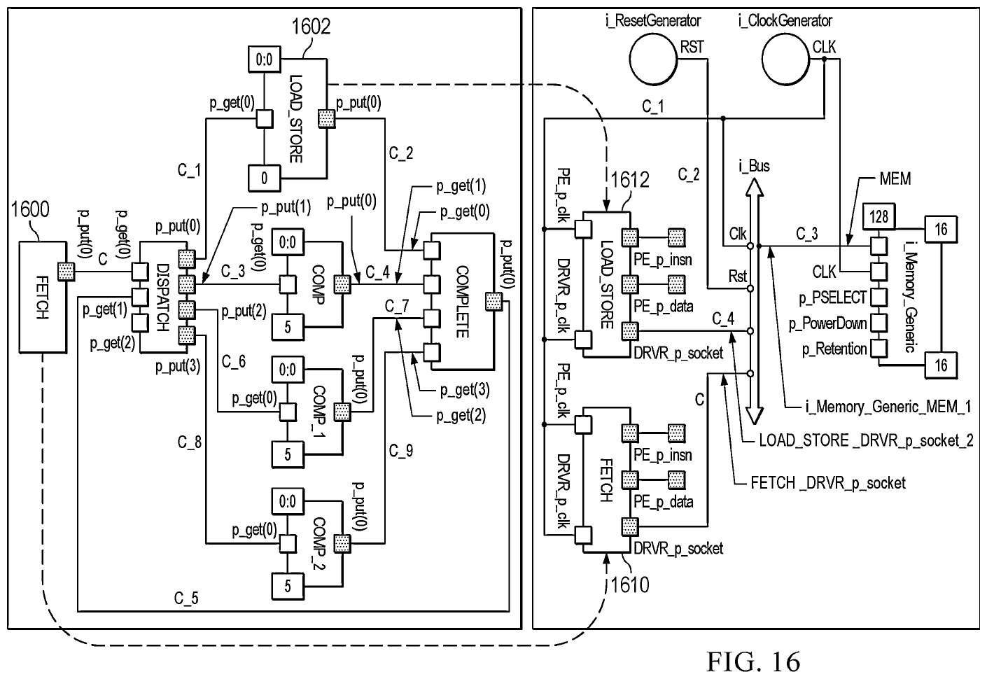

The architecture models were integrated with a SoC hardware model in the SystemC environment. FIG. 16 illustrates the integration of the architecture model of FIG. 13 with a SoC hardware model, where the Fetch 1600 and LOAD_STORE 1602 of the architecture model are mapped to a Fetch 1610 and LOAD_STORE 1612, respectively, of the SoC hardware model.

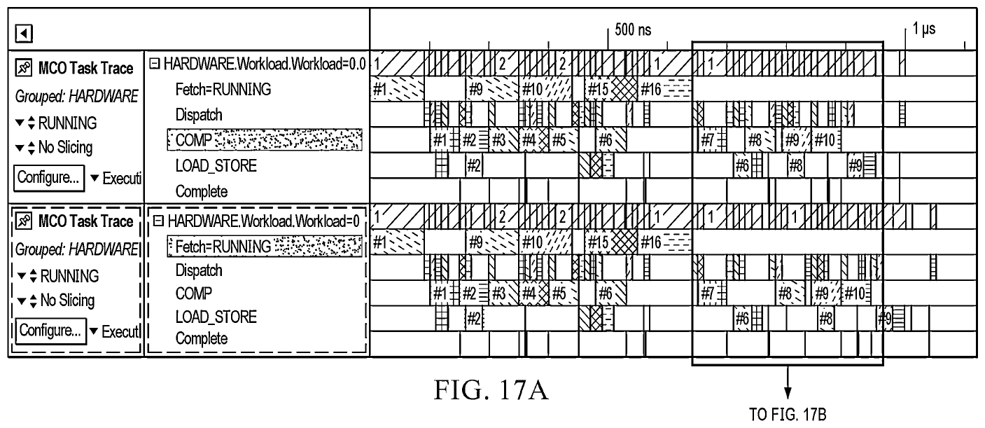

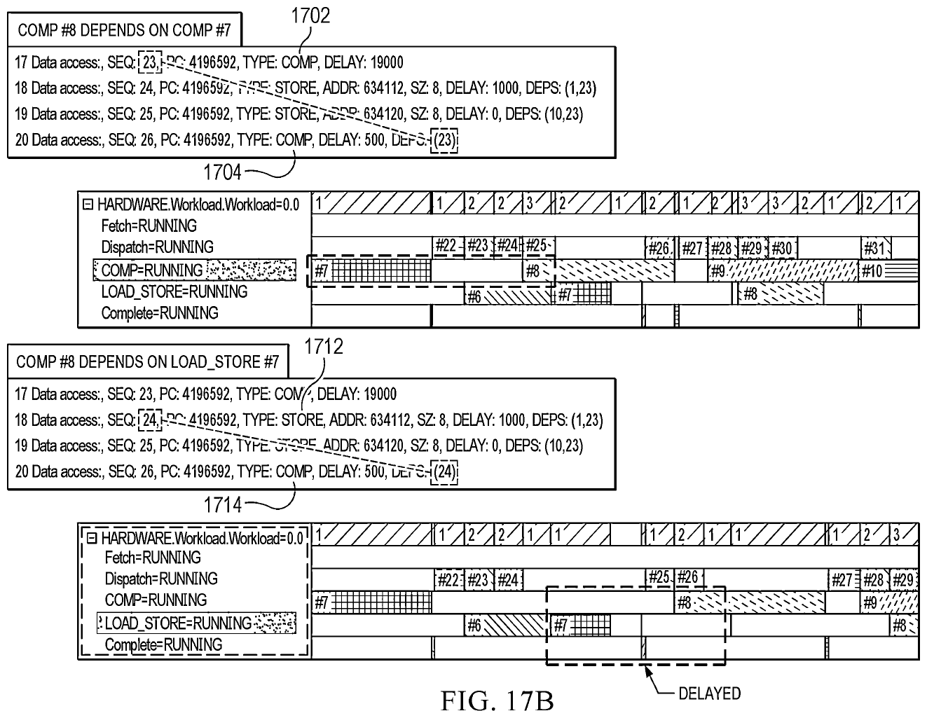

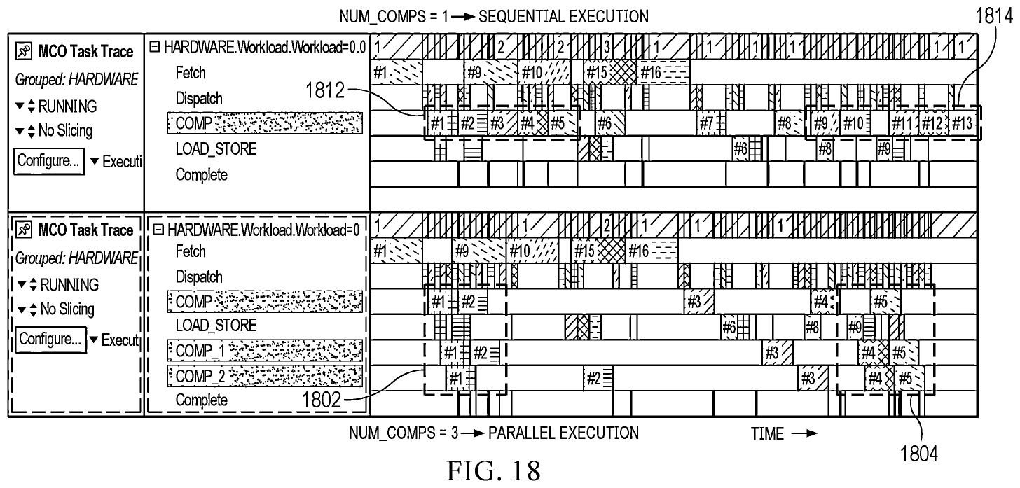

The impact of different processor architectures, such as instruction dependencies and number of execute model objects, was demonstrated on execution time in FIGS. 17A and 17B and instructions per cycle in FIG. 18. FIGS. 17A and 17B show a COMP #7 1702 with an ID=23 at line 17 for a first architecture model, and a COMP #8 1704 with an ID=26 at line 20 for the first architecture model. The COMP #8 1704 depends on the COMP #7 1702. The timing chart shows how COMP #7 1702 was executed in the simulation before the COMP #8 1704. Further, FIGS. 17A and 17B show a LOAD_STORE #7 1712 with an ID=24 at line 18 for a second architecture model, and a COMP #8 1714 with an ID=26 at line 20 for the second architecture model. The COMP #8 1714 depends on the LOAD_STORE #7 1712. The timing chart shows how LOAD_STORE #7 1712 was executed in the simulation before the COMP #8 1714. The architecture models correctly represented the command dependency, and the simulation results show the impact of dependency as delay in issue of certain commands. Architecture choices, such as having a single COMP versus three COMP, were also analyzed. With three COMP, up to three COMP type commands were observed as being executed in parallel, as shown in FIG. 18, which improved execution performance as the parallel instructions 1802, 1804 take lesser time to execute than the sequential execution 1812, 1814, respectively.

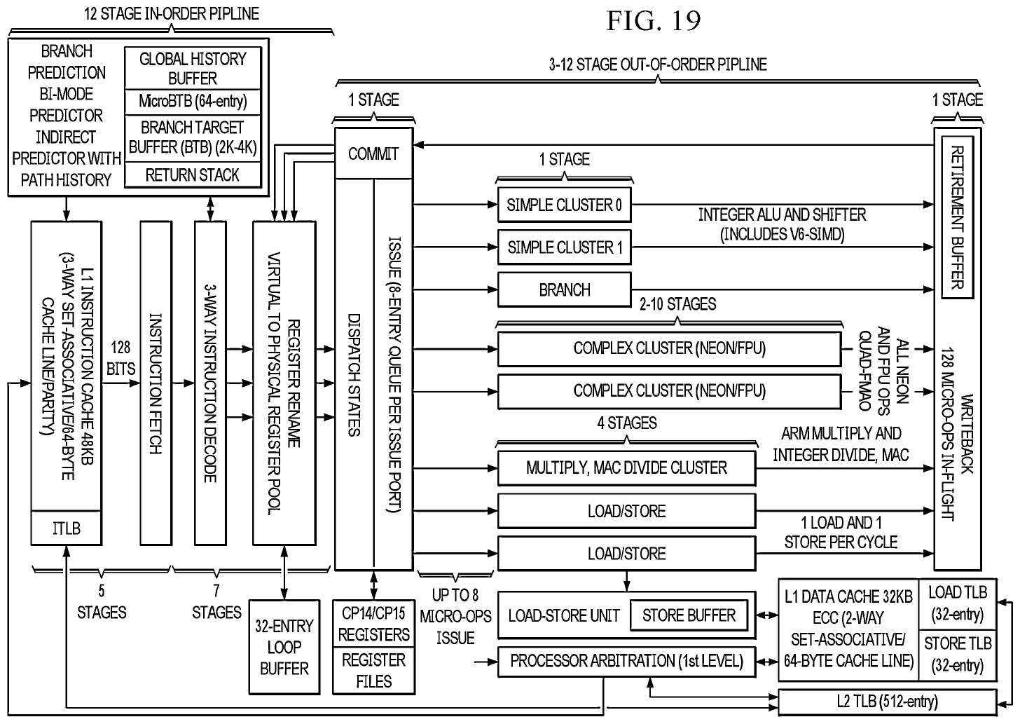

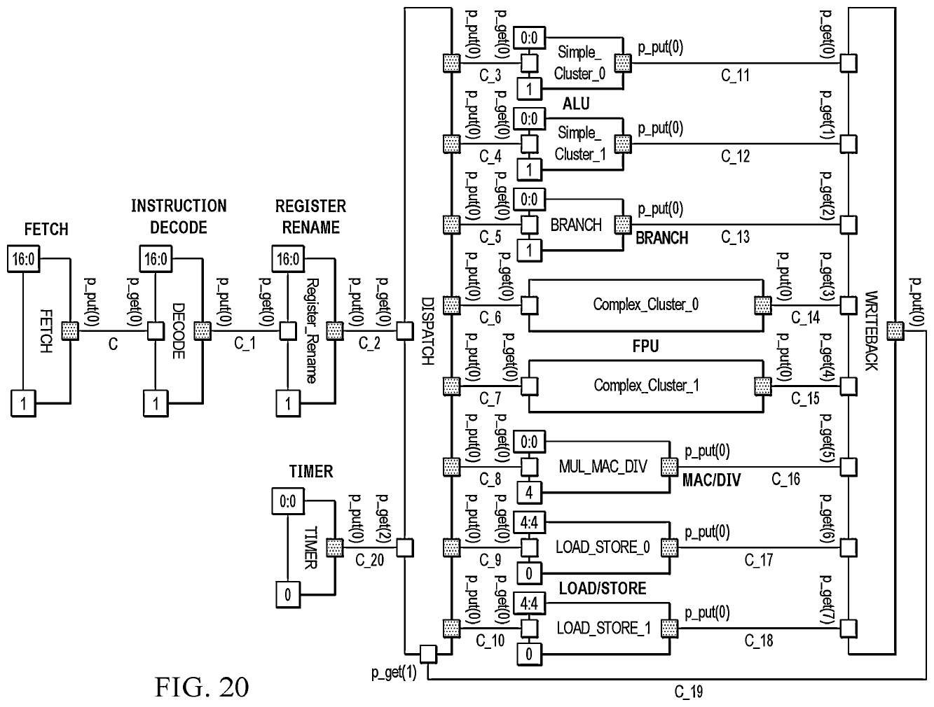

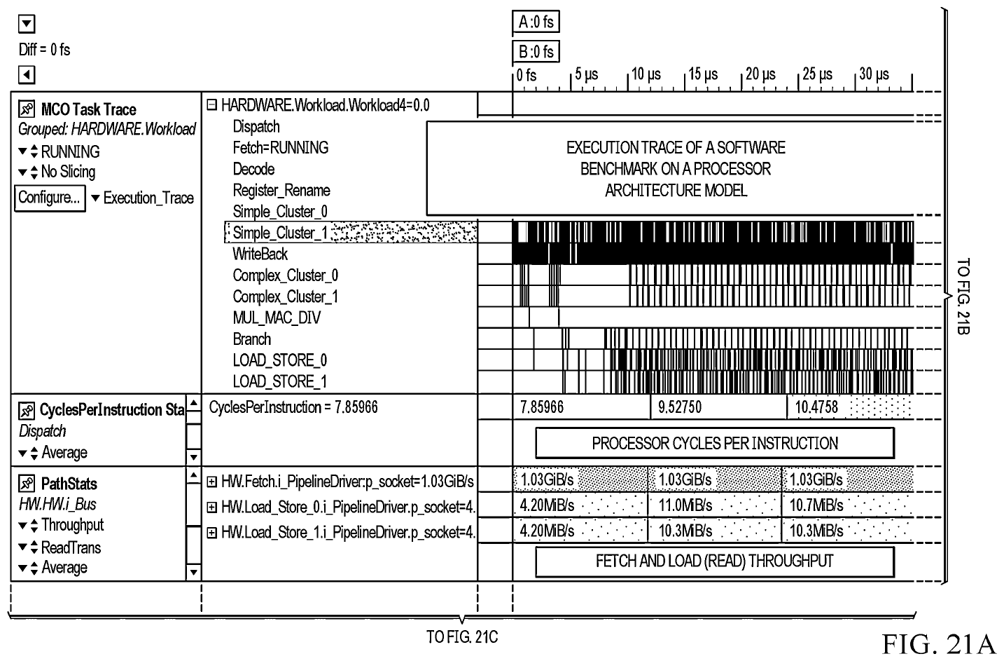

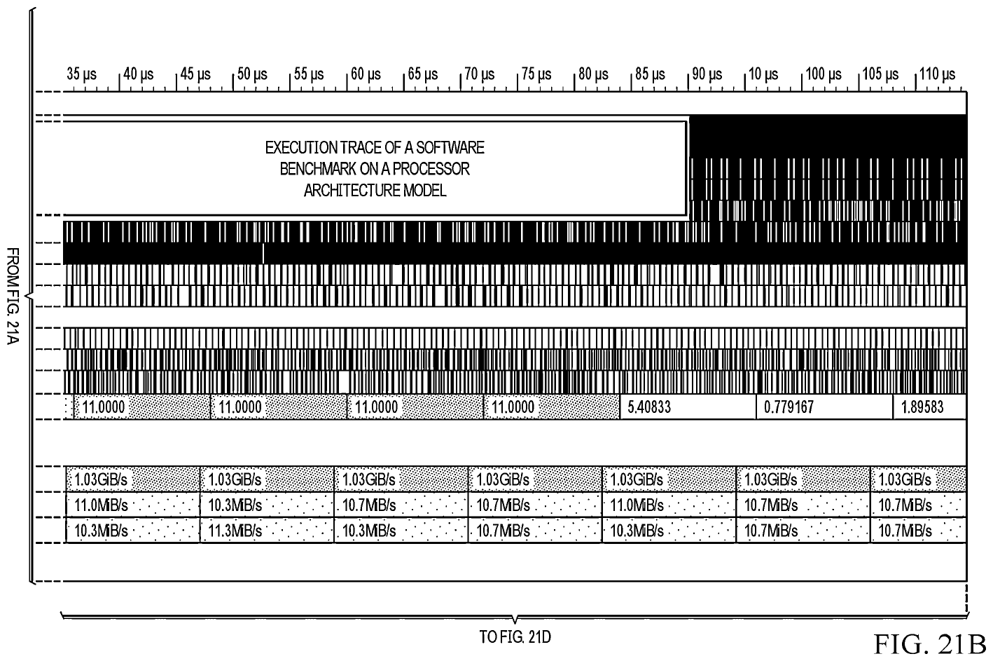

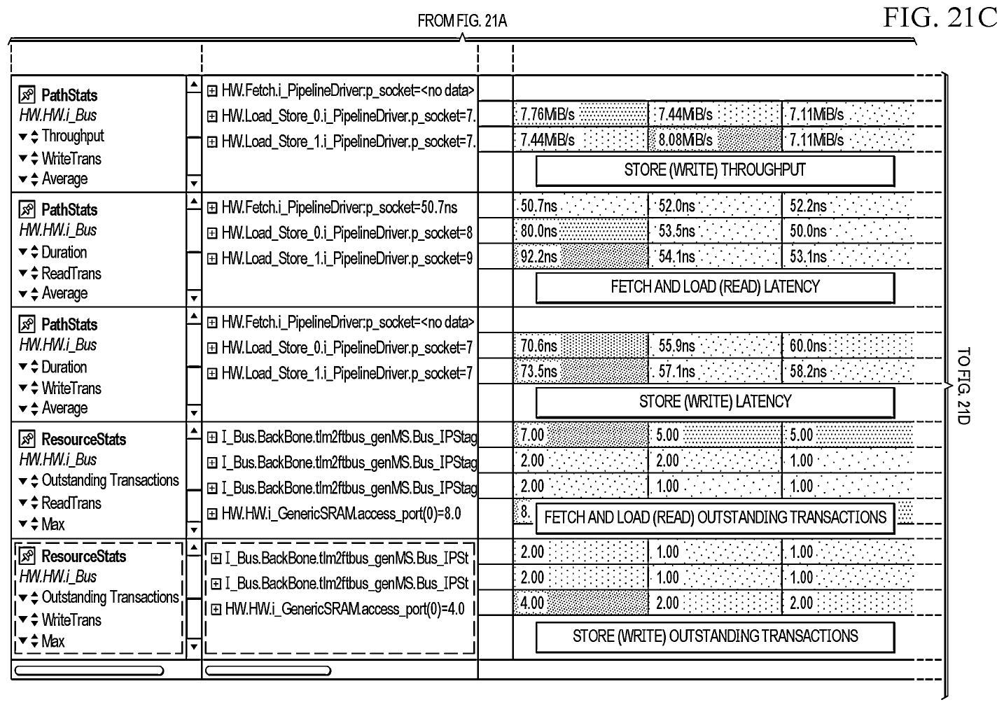

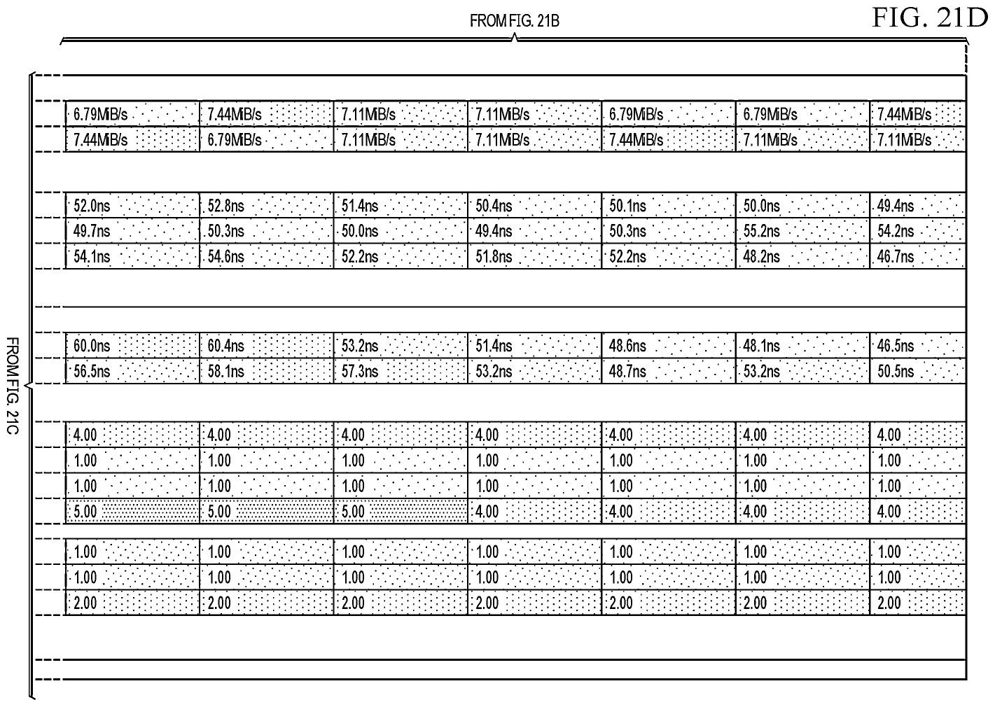

Additionally, modeling of a processor architecture is demonstrated. FIG. 19 is a diagram of an example processor architecture. FIG. 20 is an architecture model of the processor architecture shown in FIG. 19. A software instruction trace, which was obtained from benchmarking software executed on a loosely timed model of a processor, was converted into pseudo-instructions. The pseudo-instructions were simulated on the architecture model and an SoC hardware model incorporating the architecture model. Processor and SoC performance were analyzed. FIGS. 21A, 21B, 21C, and 21D show, in a graphical format, performance information for the processor and SoC performance analysis of software benchmark trace on the architecture model of a processor architecture. With the multiple execute model objects, multiple (e.g., three) commands were observed to be issued per cycle.

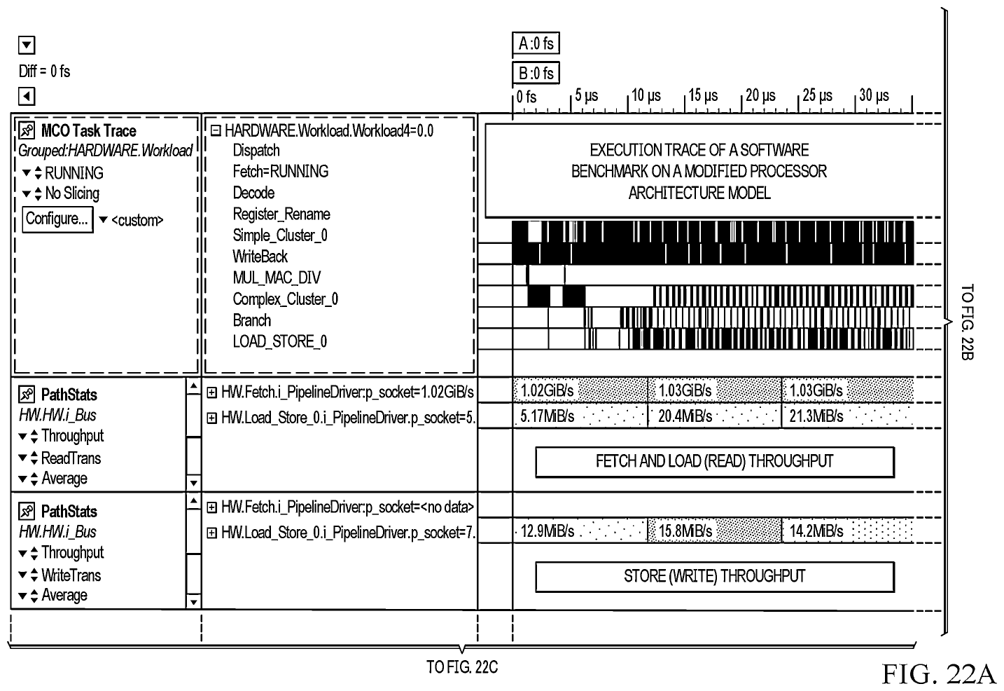

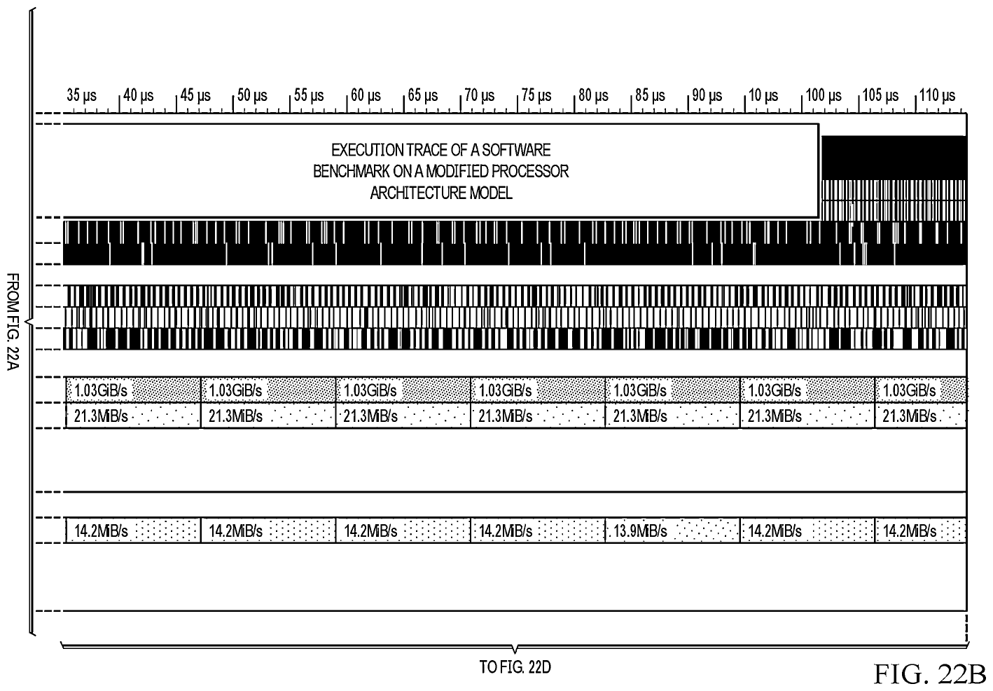

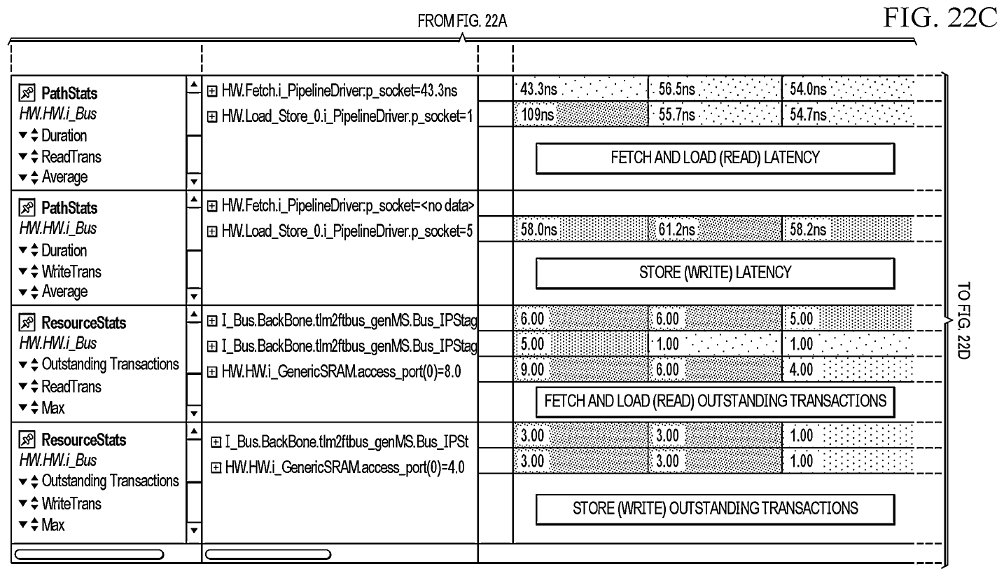

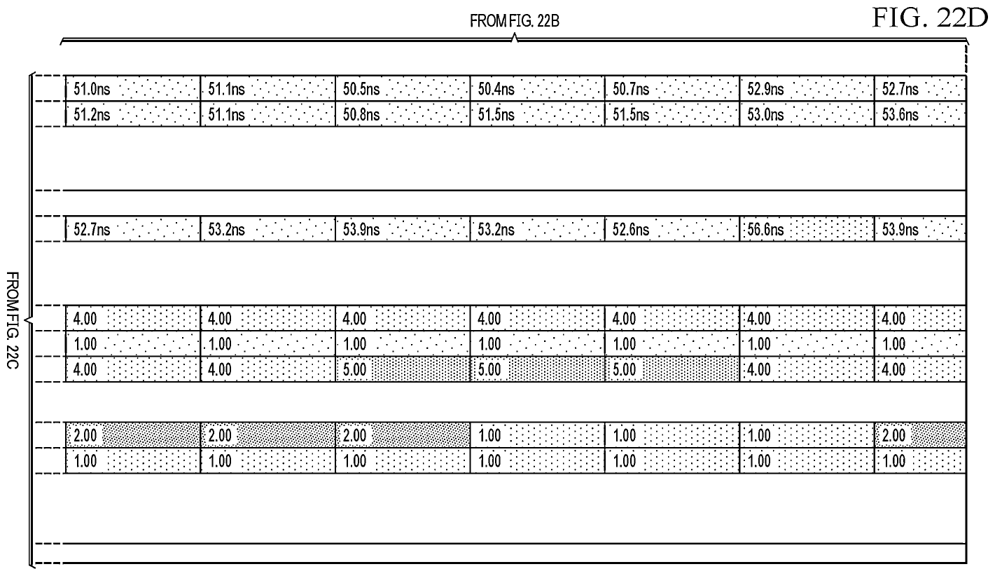

The architecture model was modified with different processor configurations, such as number of execute model objects and number of dispatches per cycle, and the different architecture models were simulated using the same software trace. FIGS. 22A, 22B, 22C, and 22D show, in a graphical format, performance information for a modified processor and SoC performance analysis of software benchmark trace on the architecture model of the modified processor architecture.

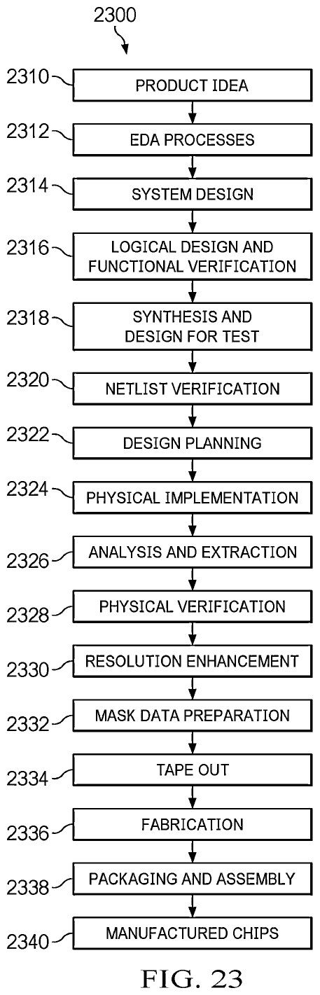

FIG. 23 illustrates an example set of processes 2300 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 2310 with information supplied by a designer, information which is transformed to create an article of manufacture that uses a set of EDA processes 2312. When the design is finalized, the design is taped-out 2334, which is when artwork (e.g., geometric patterns) for the integrated circuit is sent to a fabrication facility to manufacture the mask set, which is then used to manufacture the integrated circuit. After tape-out, a semiconductor die is fabricated 2336 and packaging and assembly processes 2338 are performed to produce the finished integrated circuit 2340.

Specifications for a circuit or electronic structure may range from low-level transistor material layouts to high-level description languages. A high-level of representation may be used to design circuits and systems, using a hardware description language (HDL) such as VHDL, Verilog, System Verilog, SystemC, MyHDL or Open Vera. The HDL description can be transformed to a logic-level register transfer level (RTL) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 23. The processes described by be enabled by EDA products (or EDA systems).

During system design 2314, functionality of an integrated circuit to be manufactured is specified. Simulation of a processor and/or SoC may occur during system design 2314, and system design 2314 may further include architecture exploration as described previously. The design may be optimized for desired characteristics such as power consumption, performance, area (physical and/or lines of code), and reduction of costs, etc. Partitioning of the design into different types of modules or components can occur at this stage.

During logic design and functional verification 2316, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 2318, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 2320, the netlist is checked for compliance with timing constraints and for correspondence with the HDL code. During design planning 2322, an overall floor plan for the integrated circuit is constructed and analyzed for timing and top-level routing.

During layout or physical implementation 2324, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on standard cells) such as size and made accessible in a database for use by EDA products.

During analysis and extraction 2326, the circuit function is verified at the layout level, which permits refinement of the layout design. During physical verification 2328, the layout design is checked to ensure that manufacturing constraints are correct, such as DRC constraints, electrical constraints, lithographic constraints, and that circuitry function matches the HDL design specification. During resolution enhancement 2330, the geometry of the layout is transformed to improve how the circuit design is manufactured.

During tape-out, data is created to be used (after lithographic enhancements are applied if appropriate) for production of lithography masks. During mask data preparation 2332, the ‘tape-out’ data is used to produce lithography masks that are used to produce finished integrated circuits.

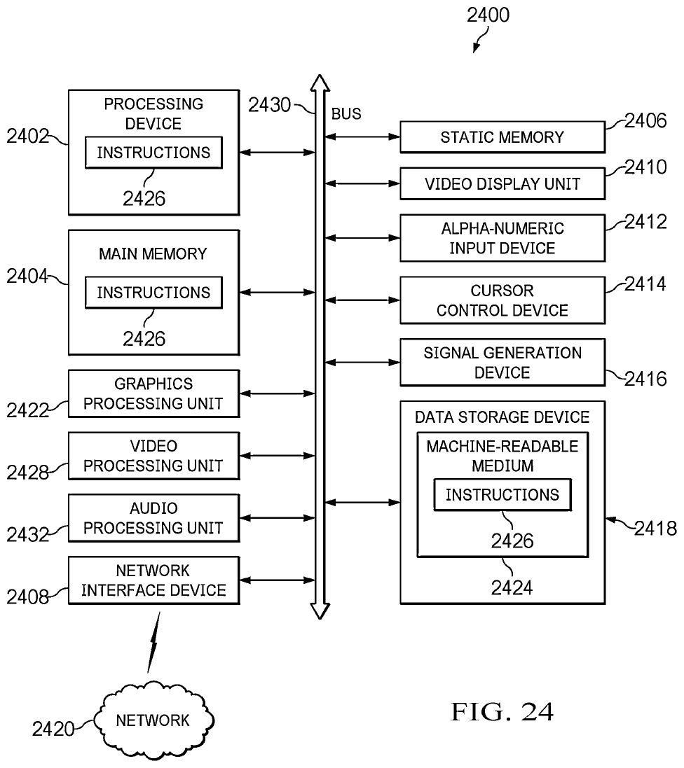

A storage subsystem of a computer system (such as computer system 2400 of FIG. 24) may be used to store the programs and data structures that are used by some or all of the EDA products described herein, and products used for development of cells for the library and for physical and logical design that use the library.

FIG. 24 illustrates an example machine of a computer system 2400 within which a set of instructions, for causing the machine to perform any one or more of the methodologies discussed herein, may be executed. More particularly, the computer system 2400 may include stored instruction (e.g., stored on a non-transitory computer readable medium) that, when executed by one or more processors of the computer system 2400, implement the methodologies, in whole or in part, of any of methods 700, 900, 1000 of FIGS. 7, 9 and 10. In various examples, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 2400 includes a processing device 2402, a main memory 2404 (e.g., read-only memory (ROM), flash memory, dynamic random access memory (DRAM) such as synchronous DRAM (SDRAM), a static memory 2406 (e.g., flash memory, static random access memory (SRAM), etc.), and a data storage device 2418, which communicate with each other via a bus 2430.

Processing device 2402 represents one or more processors such as a microprocessor, a central processing unit, or the like. More particularly, the processing device 2402 may be a complex instruction set computing (CISC) microprocessor, a reduced instruction set computing (RISC) microprocessor, a very long instruction word (VLIW) microprocessor, or a processor implementing other instruction sets, or processors implementing a combination of instruction sets. Processing device 2402 may also be one or more special-purpose processing devices such as an application specific integrated circuit (ASIC), a field programmable gate array (FPGA), a digital signal processor (DSP), network processor, or the like. The processing device 2402 may be configured to execute instructions 2426 for performing the operations and steps described herein.

The computer system 2400 may further include a network interface device 2408 to communicate over the network 2420. The computer system 2400 also may include a video display unit 2410 (e.g., a liquid crystal display (LCD) or a cathode ray tube (CRT)), an alphanumeric input device 2412 (e.g., a keyboard), a cursor control device 2414 (e.g., a mouse), a graphics processing unit 2422, a signal generation device 2416 (e.g., a speaker), graphics processing unit 2422, video processing unit 2428, and audio processing unit 2432.

The data storage device 2418 may include a machine-readable storage medium 2424 (also known as a non-transitory computer-readable medium) on which is stored one or more sets of instructions 2426 or software embodying any one or more of the methodologies or functions described herein. The instructions 2426 may also reside, completely or at least partially, within the main memory 2404 and/or within the processing device 2402 during execution thereof by the computer system 2400, the main memory 2404 and the processing device 2402 also constituting machine-readable storage media.

In some implementations, the instructions 2426 include instructions to implement functionality corresponding to the present disclosure. While the machine-readable storage medium 2424 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 2402 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms within a computer memory. These algorithmic descriptions are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, compact disc read-only memories (CD-ROMs), and magnetic-optical disks, read-only memories (ROMs), random access memories (RAMs), erasable programmable read-only memories (EPROMs), electrically erasable programmable read-only memories (EEPROMs), magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (ROM), random access memory (RAM), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
populating a control flow graph with instances of model objects, each instance of the instances of the model objects representing a respective stage of a first processor architecture design;
interconnecting the instances of the model objects in the control flow graph, the interconnected instances of the model objects being an architecture model representing the first processor architecture design; and
outputting, by one or more processors, the architecture model including the interconnected instances of the model objects.

2. The method of claim 1, further comprising:
simulating execution of pseudo-instructions by the architecture model, the pseudo-instructions being generated from a software trace; and
generating performance information based on the simulation of the execution of the pseudo-instructions by the architecture model.

3. The method of claim 2, further comprising:
receiving the software trace comprising instructions; and
converting each instruction of the instructions of the software trace into a respective pseudo-instruction of the pseudo-instructions.

4. The method of claim 3, wherein converting each instruction of the instructions of the software trace into the respective pseudo-instruction of the pseudo-instructions includes excluding operands of the respective instruction in the respective pseudo-instruction.

5. The method of claim 2, wherein the software trace is from execution or simulation of execution of instructions by a processor having a second processor architecture different from the first processor architecture design.

6. The method of claim 2, wherein the pseudo-instructions are agnostic with respect to an instruction set architecture (ISA) of the first processor architecture design.

7. The method of claim 1, wherein each instance of the instances of the model objects represents one or more of a control logic, a timing, and a memory access for the respective stage of the first processor architecture design.

8. The method of claim 1, wherein each instance of the instances of the model objects represents the respective stage excluding non-memory access functional behavior of the respective stage.

9. The method of claim 1 further comprising:
connecting a first traffic driver to a fetch model object instance, the instances of the model objects including the fetch model object instance, the first traffic driver being a model configured to generate first transactions for accessing memory outside of the architecture model; and
connecting a second traffic driver to a load-store model object instance, the instances of the model objects including the load-store model object instance, the second traffic driver being a model configured to generate second transactions for accessing memory outside of the architecture model.

10. A non-transitory computer readable medium comprising stored instructions, which when executed by a processor, cause the processor to:
populate a control flow graph with instances of model objects, each instance of the instances of the model objects representing a respective stage of a first processor architecture design;
interconnect the instances of the model objects in the control flow graph, the interconnected instances of the model objects being an architecture model representing the first processor architecture design; and
output the architecture model including the interconnected instances of the model objects.

11. The non-transitory computer readable medium of claim 10, wherein the instructions, when executed by a processor, cause the processor to:
simulate execution of pseudo-instructions by the architecture model, the pseudo-instructions being generated from a software trace; and
generate performance information based on the simulation of the execution of the pseudo-instructions by the architecture model.

12. The non-transitory computer readable medium of claim 10, wherein each instance of the instances of the model objects represents one or more of a control logic, a timing, and a memory access for the respective stage of the first processor architecture design.

13. The non-transitory computer readable medium of claim 10, wherein each instance of the instances of the model objects represents the respective stage excluding non-memory access functional behavior of the respective stage.

14. The non-transitory computer readable medium of claim 10, wherein the instructions, when executed by a processor, cause the processor to connect a traffic driver to a fetch model object instance, the instances of the model objects including the fetch model object instance, the traffic driver being a model configured to generate transactions for accessing memory outside of the architecture model.

15. A method comprising:
generating, using one or more processors, an architecture model representing a first processor architecture, the architecture model comprising interconnected instances of model objects in a control flow graph, each instance of the instances representing a respective stage of the first processor architecture;
receiving a software trace including instructions;
converting the instructions to pseudo-instructions that are instruction set architecture (ISA) agnostic;
simulating execution of the pseudo-instructions by the architecture model; and
generating performance information of the first processor architecture based on the simulation.

16. The method of claim 15, wherein each instance of the instances represents control logic, timing, memory access, or a combination thereof for the respective stage of the first processor architecture and does not implement non-memory access functional behavior of the respective stage of the first processor architecture.

17. The method of claim 15, wherein the software trace is from execution or simulation of execution of the instructions by a processor having a second processor architecture different from the first processor architecture.

18. The method of claim 15, wherein converting the instructions into the pseudo-instructions includes, for each instruction of the instructions:
determining a pseudo mnemonic of a pseudo-instruction based on a mnemonic of the respective instruction;
attaching a unique identifier to the pseudo-instruction;
attaching memory access operands to the pseudo-instruction when the mnemonic of the respective instruction indicates that the respective instruction is a memory access instruction;
determining whether the respective instruction is dependent upon execution of a preceding instruction; and
attaching a dependency to the pseudo-instruction when the respective instruction is dependent upon execution of a preceding instruction.

19. The method of claim 15, wherein each pseudo-instruction of the pseudo-instructions does not include non-memory access operands.

20. The method of claim 15, wherein the instances of the model objects included in the architecture model comprise:
an instance of a fetch model object configured to fetch the instructions of the software trace;
an instance of a decode model object configured to convert the instructions to the pseudo-instructions;
an instance of a dispatch model object configured to route the pseudo-instructions;
one or more instances of one or more execute model objects configured to simulate execution of respective pseudo-instructions received from the instance of the dispatch model object; and
an instance of a completion model object configured to indicate when simulation of execution of respective pseudo-instructions is complete, the instance of the dispatch model object further being configured to retire pseudo-instructions based on an indication of completion received from the instance of the completion model object.
